(19) United States
(12) Patent Application Publication
(10) Pub. No.: US 2015/0044341 A1
(43) Pub. Date: Feb. 12, 2015

(54) CONTAINER FOR PRESERVATION OF PERISHABLE FOOD ITEMS

(71) Applicant: Julianne L. Nolan, West Babylon, NY (US)

(72) Inventor: Julianne L. Nolan, West Babylon, NY (US)

(21) Appl. No.: 14/524,782

(22) Filed: Oct. 27, 2014

Related U.S. Application Data
(62) Division of application No. 13/453,359, filed on Apr. 23, 2012.
(60) Provisional application No. 61/478,256, filed on Apr. 22, 2011.

(51) Int. Cl. A23B 7/04

(52) U.S. Cl. CPC A23B 7/0433; A23V 2002/00
USPC 426/395

(57) ABSTRACT

A container for preserving food items includes a sidewall extending from a sidewall base, the sidewall defining an open interior space and a rim of the sidewall defining an opening in the container, the opening providing access to the open interior space. The container is constructed of an organic cotton fabric having a density of about 6-10 ounces per square yard (oz./sq. yd.).

### PRIORITY

This application is a divisional application of U.S. patent application Ser. No. 13/453,359 filed by Nolan on Apr. 23, 2012, which claims priority under 35 U.S.C. §119(e) to U.S. Provisional Application No. 61/478,256 filed on Apr. 22, 2011 with the United States Patent and Trademark Office, the entire contents of which are incorporated herein by reference.

### BACKGROUND OF THE INVENTION

1. Field Of The Invention

The present invention relates generally to a container, and more particularly, to a reusable container for preserving perishable food items.

2. Brief Description Of The Related Art

Consumption of fresh fruits and vegetables is the first step towards a healthy diet. However, due to quick spoilage, eating fresh fruits and vegetables is challenging. There are several contributing factors to the quick spoilage of fruits and vegetables.

After fruits and vegetables are harvested, they begin to emit ethylene, a colorless and odorless gas. Ethylene emission is a part of the ripening process, but also results in faster spoilage. Some fruits and vegetables are strong ethylene emitters, while others are low emitters. Some fruits and vegetables are more sensitive to ethylene, meaning that they decay faster in its presence, while others are less so. For example, cantaloupe exhibits a high rate of ethylene production, but has only a medium level of sensitivity. Conversely, watermelon emits a low rate of ethylene, but is highly sensitive to its presence. These observations have led the agriculture industry to develop guidelines setting forth which fruits and vegetables can be stored together and which should be stored separately due to differences in ethylene emission and sensitivity.

Aside from keeping incompatible fruits and vegetables separate, slowing the rate of spoilage requires a balance between allowing ethylene gas to escape while also containing the fruits and vegetables to slow the rate of respiration. Refrigeration is one method for slowing the rate of respiration of fruits and vegetables.

### SUMMARY OF THE INVENTION

The present invention has been made to address at least the above problems and/or disadvantages and to provide at least the advantages described below. Accordingly, an aspect of the present invention relates to a container for preserving perishable food items.

According to one aspect of the present invention, a container is provided. The container for preserving food items includes a sidewall extending from a sidewall base, the sidewall defining an open interior space and a rim of the sidewall defining an opening in the container, the opening providing access to the open interior space. The container is constructed of an organic cotton fabric having a density of about 6-10 ounces per square yard (oz./sq. yd.).

According to another aspect of the present invention, a reusable container is provided. A reusable container for preserving produce includes a sidewall extending from a sidewall base, the sidewall defining an open interior space and an opening providing access to the open interior space. The container is constructed of an organic cotton fabric, the organic cotton fabric having a density of about 6-10 ounces per square yard (oz./sq. yd.).

### BRIEF DESCRIPTION OF THE DRAWINGS

The above and other objects, features and advantages of certain embodiments of the present invention will be more apparent from the following detailed description taken in conjunction with the accompanying drawings, in which:

FIG. 1 illustrates a reusable container according to an embodiment of the present invention;

FIG. 2 is a table illustrating results of experiments on control groups indicating how typical fruits and vegetables ripen and begin to spoil over a given period of time while stored in a refrigerator;

FIG. 3 is a table illustrating results of experiments on fruits and vegetables stored in a reusable container according to an embodiment of the present invention compared with typical plastic bags; and

FIG. 4 is a table illustrating results of experiments on fruits and vegetables stored in a reusable container according to an embodiment of the present invention compared with a typical rigid plastic container.

### DETAILED DESCRIPTION OF EMBODIMENTS OF THE PRESENT INVENTION

The following detailed description of embodiments of the present invention will be made with reference to the accompanying drawings. In describing the invention, an explanation of related functions or constructions known in the art is omitted for the sake of clarity in understanding the concept of the invention that would otherwise obscure the invention with unnecessary detail.

A reusable container, according to an embodiment of the present invention, is constructed of an organic fabric, such as an organic cotton fabric, not typically used for such applications. Specifically, the organic cotton fabric has a density of about 6-10 ounces per square yard (oz./sq. yd.). The density of the organic cotton may be 8 oz./sq. yd. according to an embodiment of the present invention. The organic cotton fabric may have a woven structure of warp and fill yarns. Further, according to an embodiment of the present invention, the fill yarns have a denier (d) of at least 400 d and the warp yarns have a denier of at least 50 d.

The organic cotton fabric is a light to medium duty fabric having an abrasion resistance of between 3,000-15,000 double rubs, seam slippage of at least 40 pounds (lbs.), and load recovery of at least 95%. While the specifications above are preferable, acceptable fabrics can be, in some cases, realized in which the abrasion resistance is 6,000 double rubs and the load recovery is 90%. The organic cotton fabric may be obtained from a company such as Organic Cotton Plus and is preferably certified according to the Global Organic Textile Standard (GOTS).

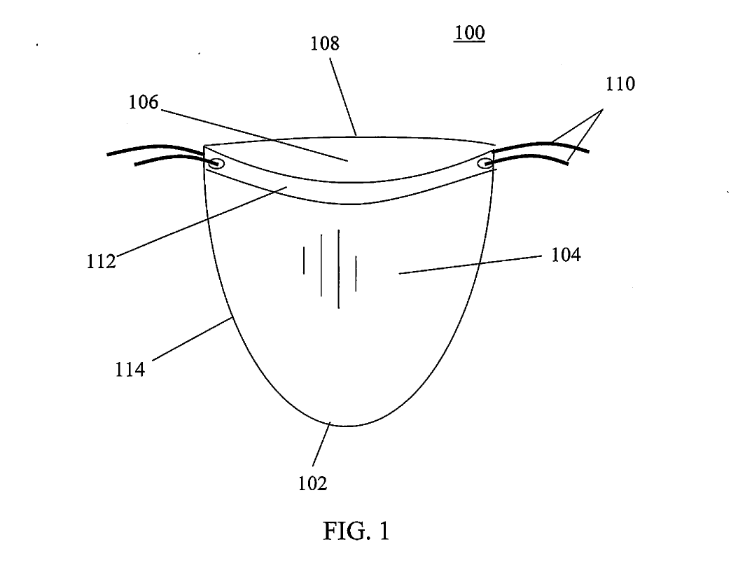

Referring initially to FIG. 1, FIG. 1 illustrates a reusable container according an embodiment of the present invention. Specifically, a reusable container 100 is configured in a bag-like structure and may be constructed in a variety of shapes, such as a cylinder, a cube, a cuboid, a pyramid or a sphere. The reusable container 100 is constructed of a flexible material, such as the organic cotton fabric described above. The reusable container 100 includes a sidewall 104 extending from a sidewall base 102, with one or more edges of the sidewall 104 joined at a seam 114. The sidewall 104 defines an open interior space 106 and an opening provides access to the open interior space 106. A rim 108 extends along an upper edge of the sidewall 104, and defines the opening.

In an embodiment of the present invention, the sidewall 104 may include a plurality of sidewalls attached by one or more sidewall seams to form the reusable container 100. The plurality of sidewalls may be attached to the sidewall base 102 by a base seam. More particularly, the sidewall base 102 may be configured as a flat surface, the plurality of sidewalls therefore extending perpendicularly up from the sidewall base 102. The flat surface of the sidewall base 102 allows the reusable container to stand upright.

A drawstring 110, or other type of closure mechanism, may be strung within a seam 112. The seam 112 runs around the rim 108 of the opening. The drawstring 110 includes a plurality of strings strung within the seam 112. The strings exit the seam 112 at seam openings located at opposite sides of the rim 108. Pulling the strings away from the reusable container 100 tightens the strings. The opening, and therefore the open interior space 106, is secured in a substantially closed position when the drawstring 110 is pulled tight. Securing the opening closed with the drawstring 110 allows for some minimal venting of the open interior space 106. The opening generally remains about 0.1-3 inches open when the drawstring is tightened. Specifically, optimal gas exchange occurs when the opening is 1-2 inches open. However, the opening may also be secured completely closed by, for example, a zipper running along the rim 108 of the opening.

Constructing the reusable container 100 of the organic cotton fabric described above, in conjunction with the minimal venting provided when the opening is pulled closed by the drawstring 110, achieves an optimal balance of restriction of respiration while allowing gas to escape. Specifically, the reusable container slows the ripening and spoilage of fruits and vegetables by absorbing and/or releasing ethylene gas and water, while concurrently keeping produce fresh by creating a barrier to restrict respiration. Thus, the reusable container achieves the balance of slowing respiration of the stored fruit or vegetable through containment while allowing ethylene gas and moisture to escape.

Results of several experiments are provided herein demonstrating the efficacy of the above-described organic cotton fabric as a reusable container. The results presented are unexpectedly successful compared with typical products available for preservation of perishable food items, such as fruits and vegetables.

All fruits and vegetables were refrigerated at 40° F. Results may vary depending on refrigerator temperature, amount and type of food in a container, open air flow of the refrigerator, and the stage of the fruit and vegetable's ripening at the time of purchase. Where a fruit or vegetable became rotten prior to the observation date, the data is indicated as Not Applicable (“N/A”).

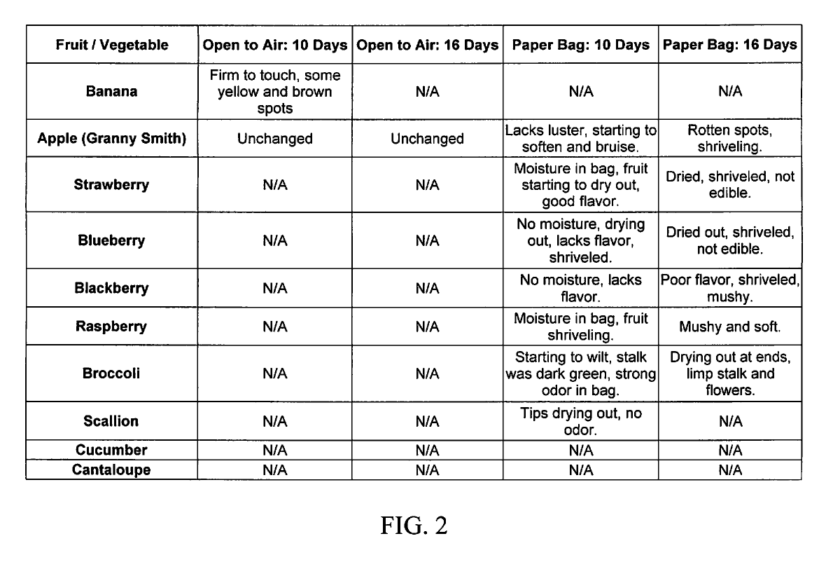

Referring now to FIG. 2, FIG. 2 is a table illustrating results of experiments on control groups indicating how typical fruits and vegetables ripen and begin to spoil over a given period of time while stored in a refrigerator. Specifically, the results provided in FIG. 2 demonstrate that fruits and vegetables stored in open air or in a paper bag in a refrigerated environment generally last for less than 10 days before showing signs of decay, mold, wilting or mushiness. Fruits stored in a paper bag in a refrigerator, such as red and black berries, become dry, mushy, and shriveled within 10 days. Vegetables, also stored for 10 days in a paper bag, become limp, wilted and dry.

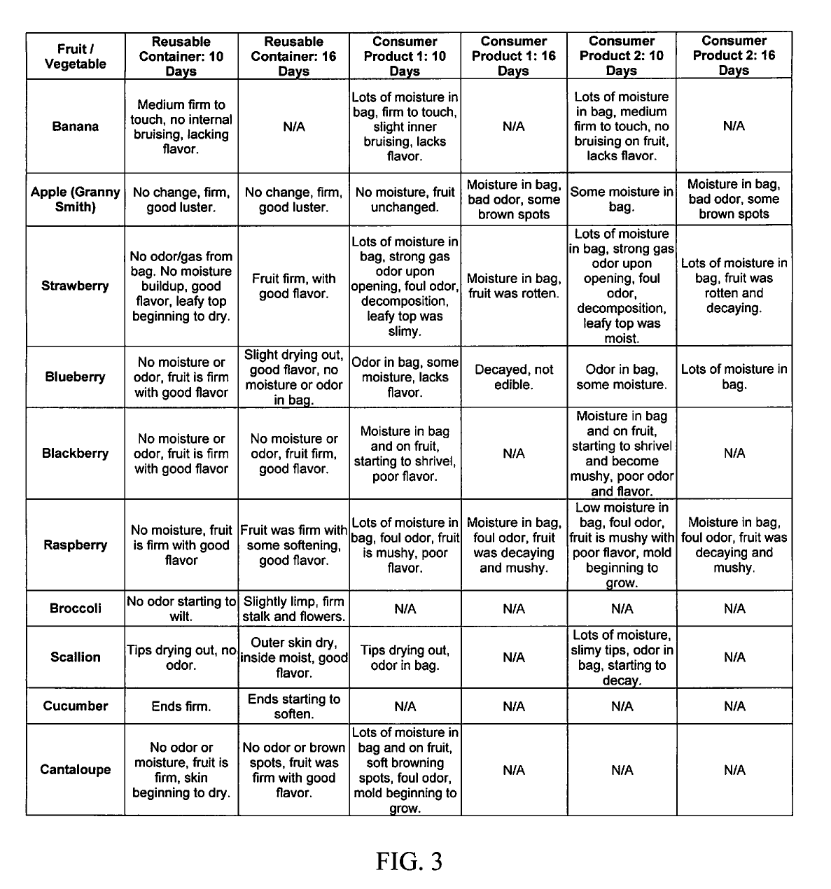

Referring now to FIG. 3, FIG. 3 is a table illustrating results of experiments on fruits and vegetables stored in a reusable container according to an embodiment of the present invention compared with typical plastic bags. Specifically, FIG. 3 compares the reusable container 100 to Consumer Product 1, which represents a typical plastic bag claiming to absorb ethylene gas and Consumer Product 2, which represents a plastic storage bag claiming to allow ethylene gas to escape while preserving fruits and vegetables within.

The results provided in FIG. 3 demonstrate that various berries stored in the reusable container retain their color and flavor for up to 16 days. The vegetables stored in the reusable container show slight degradation, but are generally still usable.

However, the fruits and vegetables stored in Consumer Products 1 and 2 become mushy and soft within 10 days and show signs of mold and decomposition. Berries stored in Consumer Products 1 and 2 experience early softening, loss of flavor and color, as well as decay. The fruit generally tastes foul, leaving an aftertaste likely a result of ethylene gas absorption. The vegetables also show signs of decay within 10 days and become slimy and wilted. For both the fruits and vegetables, observations indicate that Consumer Products 1 and 2 retain moisture as well as ethylene gas.

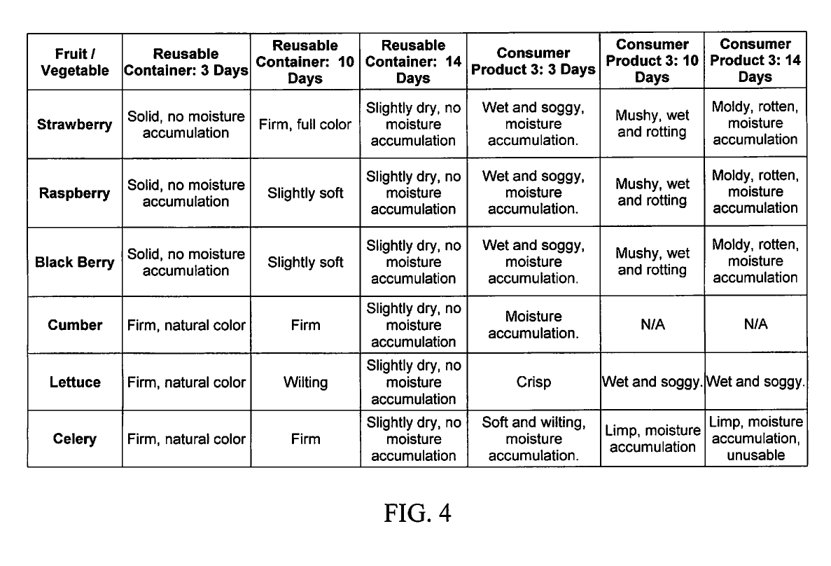

Referring now to FIG. 4, FIG. 4 is a table illustrating results of experiments on fruits and vegetables stored in a reusable container according to an embodiment of the present invention compared with a typical rigid plastic container. The typical rigid plastic container, identified as Consumer Product 3, is a made of solid plastic and includes adjustable vents that attempt to provide control of airflow.

The results provided in FIG. 4 demonstrate that after three days of refrigeration the fruits remain solid, with no moisture accumulation observed in the reusable container or on the fruit. Lettuce, cucumbers and celery also remain firm and with natural color. In contrast, moisture accumulates on an inside portion of a lid of Consumer Product 3, and the berries appear wet and soggy. Moisture does not noticeably escape from Consumer Product 3 despite the adjustable vent.

After 10 days, strawberries stored in the reusable container of the present invention remain firm and full of color, while black berries and raspberries are slightly soft. The cucumber and celery stored in the reusable container remain firm, while the lettuce is wilted. The fruits stored in Consumer Product 3 are mushy, wet and rotting. The lettuce stored in Consumer Product 3 is soggy and the celery is limp with accumulated moisture.

After 14 days, the fruits and vegetables stored in the reusable container are slightly dry, with no moisture accumulation on the fruit or in the reusable container. The fruit stored in Consumer Product 3 is moldy and rotten with moisture accumulation within the container. The lettuce stored in Consumer Product 3 is wet and soggy, while the celery is limp and unusable.

While the invention has been shown and described with reference to certain embodiments of the present invention it will be understood by those skilled in the art that various changes in form and details may be made therein without departing from the spirit and scope of the invention as defined by the appended claims and their equivalents.

What is claimed is:

1. A method for preserving food, the method comprising:
placing a food item in a reuseable container having an opening at a proximal end thereof for receiving the food item, the reusable container constructed of an organic cotton fabric having a density ranging from 6 to 10 ounces per square yard;
at least partially closing the proximal end of the reusable container; and
storing the reusable container in a temperature controlled environment.

2. The method according to claim 1, wherein closing the proximal end of the reusable container comprises pulling a drawstring away from the reusable container.

3. The method according to claim 1, wherein in the partially closed configuration the reusable container remains 0.1 inches to 3 inches open for slowing respiration and allowing ethylene gases produced by the food item placed in reusable container to escape.

4. The method according to claim 1, wherein in the partially closed configuration at least one of moisture and ethylene gas, which are produced by the food item placed in the reusable container, is at least one of expelled through the opening of the reusable container and absorbed by the organic cotton fabric.

5. The method according to claim 1, wherein the resusable container includes a bag-like configuration having a shape selected from the group consisting of a cylinder, a cube, a cuboid, a pyramid and a sphere.

6. The method according to claim 1, wherein storing the reusable container comprises storing the reusable container in a refrigerator thereby further preserving shelf life and freshness of the food item placed in the reusable container.
